(19) United States
(12) Patent Application Publication
(10) Pub. No.: US 2026/0177035 A1
(43) Pub. Date: Jun. 25, 2026

(54) METHODS FOR DETERMINING LOADS ON WIND TURBINES

(71) Applicant: Wobben Properties GmbH, Aurich (DE)

(72) Inventors: Milan DAMMINGER, Templin (DE); Frederik BERGER, Oldenburg (DE); Dominik TRAPHAN, Oldenburg (DE)

(21) Appl. No.: 19/217,806

(22) Filed: May 23, 2025

(30) Foreign Application Priority Data
May 28, 2024 (EP) 24178464.4

(51) Int. Cl. F03D 17/00

(52) U.S. Cl. CPC F03D 17/011; F03D 17/006; F05B 2270/331

(57) ABSTRACT

The present disclosure is directed to a method for determining loads on wind turbines. The method includes creating a grid structure with grid points from randomly varied wind conditions as parameters, the wind conditions including one or more of a turbulence, a turbulence intensity, and a wind shear, performing load simulation of a wind turbine for each of the grid points, providing a prediction model for predicting loads based on wind conditions, training the prediction model based on the load simulation for each of the grid points, and determining the loads for any combination of wind conditions using the prediction model.

### TECHNICAL FIELD

The present disclosure relates to a method for the determination of loads on wind turbines and to a training data set for training a prediction model for the prediction of loads based on wind conditions.

### BACKGROUND

Wind turbines are known. The planning and construction of wind turbines has advanced to such an extent that wear and service life of wind turbines can be roughly estimated. Never-theless, damage has been observed on wind turbines, the causes of which have not yet been sufficiently clarified. As a possible cause, a site-specific exceeding of the mechanical load capacity by extreme loads on account of extreme turbulence, for example, has been held to be possible. As a result of this, all sites of wind turbines with a corresponding load situation, for example an extreme load in the case of extreme turbulence, should be examined with site conditions.

However, on account of the large number of sites, a check via the manual path cannot be implemented, neither by simulations nor by a systematic combination of all parameter combinations and application of mathematical interpolation methods.

### SUMMARY

An aspect of the present disclosure is directed to providing a method which determines loads on wind turbines under specific site conditions. Furthermore, aspects of the present disclosure are directed to reducing the data volume and thus to enable an expandability of the dimensionality in contrast to the previously known solution. Furthermore, a prediction of mechanical loads with substantially faster response times should be made possible. Another aspect of the present disclosure is directed to predicting component and control parameters as a function of load and site conditions.

According to a first aspect of the disclosure, a method for the determination of loads on wind turbines includes creating a grid structure with grid points from randomly varied wind conditions as parameters, in particular comprising a turbulence, a turbulence intensity and/or a wind shear; load simulation of a wind turbine for each of the grid points; creating a prediction model for the prediction of loads based on wind conditions; training the prediction model on the basis of the performed load simulations for each of the grid points; and determining the loads for any combination of wind conditions using the prediction model. With the present disclosure, it is thus possible to be able to determine the loads of a possible wind turbine for all parameters of an installation site, in that the loads are simulated for only a subset of the possible parameters, namely the combinations of parameters lying on the grid points of the grid structure, and further combinations which do not lie on the simulated grid points are derived via a trained prediction model.

The simulation of all possible parameter combinations is too complex, both in the case of the question of the memory utilization and the computing capacity, so that it does not rep-resent a possibility to simulate all combinations of parameters. Since according to the disclosure a small part of the combinations is sufficient, considerable effort can be saved in the creation of the load prediction. Thus, in particular, the energy consumption of the load prediction also falls, which meets the sustainability idea of a technology such as wind energy.

In order to close the gap between the small number of simulated parameter combinations and all possible parameter combinations, the disclosure uses a trained prediction model. The prediction model is trained on the basis of the actually simulated parameter combinations and predicts the loads for the further, non-simulated parameter combinations after the training phase with high accuracy.

As is known, a larger training data set often leads to higher accuracy, but this at the price of the higher effort for the generation of the training data set.

In this connection, loads denote all static and/or dynamic loads acting on the wind turbine considered in isolation or in combination.

The selection of the considered load or loads takes place according to the requirements. Thus, for example, loads on individual components of the wind turbine, in particular on rotor blades and/or the tower, can be considered. Rotor blades and towers of wind turbines are traditionally cost drivers, so that a design that is as slender as possible is desired. In a slender design without significant load reserves, an accurate estimation of the loads is advantageous. In one example, the loads are edgewise and/or flap wise loads of rotor blades, wherein in other examples other loads are also used.

The parameter space is spanned with a grid structure, wherein the different considered wind parameters span different dimensions of the parameter space. For example, one dimension of the grid structure is a turbulence or turbulence intensity and another dimension is a wind speed or a wind shear. The dimension of the parameter space is not restricted to two or three, the method is suitable even if a higher dimensionality of the parameter space and thus of the grid structure is used.

Grid points denote a point within the grid structure and thus a combination of a respective value of each of the dimensions of the grid structure. The distance between the individual grid points is not fixed and the number of grid points present is also not fixed. There are also no minimum and/or maximum values in the individual dimensions.

A simulation of the loads of a wind turbine is then performed for each of the grid points. A grid is thus, in a greatly simplified manner, the set of discrete (grid) points on which the solution is calculated or simulated.

A grid is thus a discretization of the space or area spanned by the parameters. It serves to be able to perform mathematical calculations on the latter which, on account of its infinite character, are not possible directly on the area or the space. Known algorithms for creating structured or unstructured grids are used for creating the grid structure.

According to aspects of the present disclosure, the use of unstructured, in particular quasi-random grid structures, i.e. from randomly varied wind conditions, have proven to be particularly efficient for saving resources. By training models instead of performing mathematical interpolations, higher accuracies can be obtained with significantly reduced resource use.

In particular a turbulence, a turbulence intensity and/or a wind shear are of interest here as wind conditions, wherein other wind conditions are also taken into consideration. One example parameter is an average meteorological turbulence intensity which describes brief fluctuations of the wind speed by the 10-minute average value. The wind shear can comprise both a (preferably) vertical and a horizontal wind shear.

It is denoted as load simulation that in particular mechanical loads of wind turbines are simulated for the wind conditions. The load simulation is thus a simulation of a specific wind turbine type under the selected wind conditions. Algorithms known to the person skilled in the art for load simulation can also be used for this. The load simulation can simulate a specific load or a plurality of loads of the wind turbine.

The prediction model is designed to make a prediction for a specific combination of input parameters. The prediction variable is a specific load, for example a blade load in an extreme load case such as the extreme load case DLC 1.3, wherein this is of course only an example. The input parameters comprise in particular the wind conditions, but can also comprise other parameters, such as parameters dependent on the wind turbine, including rated power, operating control, etc., as will also be explained in detail below.

In principle, all known models which can determine a prediction value from a combination of a plurality of input values are suitable as prediction models. Decision trees, neural networks, Eureqa models and support vector machines have proven to be advantageous in the context of the present disclosure.

The provision of a prediction model for the prediction of loads comprises a definition of the input and/or output parameters of the prediction model and of the model algorithm. According to the present disclosure, a plurality of prepared input and output parameter combinations and model algorithms can be prepared and a model suitable for the application can be selected therefrom. In other cases, the models can be generated as part of the method.

By providing training and example data, the algorithm can recognize patterns and relationships and thus learn from the data. This is known to be understood as training the prediction model, wherein the provided training data are the simulated loads using the wind conditions as input parameters. As mentioned, additional input data can optionally also be used.

Finally, the prediction model allows a determination of the loads for any combination of wind conditions. Without all combinations of wind conditions having to be simulated or having to be interpolated mathematically between simulated wind conditions, the disclosure can obtain the desired result. In contrast to the present model-based method, the interpolation also requires a large number of structured grid points in order to achieve approximate prediction reliability.

According to examples of the first aspect of the disclosure, the load simulation comprises a multi-body simulation of the entire wind turbine.

A plurality of methods and software tools for the simulation of loads on wind turbines are known. The spectrum ranges from reduced models for longer simulation times to detailed models of drive trains, of support structures or rotor blades with computational fluid dynamics (CFD) for aerodynamics.

Known simulation software is, for example, Flex5, Bladed, FAST, Finite Element Tools such as ANSYS, ABAQUS and Poseidon, the Multibody Simulation (MBS) tool SIMPACK and CFD codes including FLOWer, wherein further programs are of course also available here.

In this connection, multi-body simulations (MBS) have proven to be advantageous since they enable particularly accurate statements about the loads. Examples of programs which are suitable for the execution of MBS for wind turbines are Bladed by DNV-GL/Garrad Hassan and SIMPACK. These tools enable high-level simulations of wind turbine models. Virtually any flexible body can be modeled, such as, for example, gearwheel contacts, bearing stiffness in the drive train, the pitch system, etc. Depending on which loads are of interest according to the disclosure, the MBS models can be constructed differently or even modularly.

According to a further example of the first aspect of the disclosure, different prediction models are created for different loads, in particular for blade loads and/or tower loads.

It can thus be ensured that the prediction accuracy of a specific load, for example an extreme load on the rotor blades, is as high as possible. The models are accordingly optimized and trained specifically for the respective load.

According to a further example of the first aspect of the disclosure, the grid structure has an approximately constant density of grid points over space, and is created, for example, using a random sequence algorithm.

The approximately constant density over space prevents the grid points used for the simulation or the creation of training data from being present very frequently in a specific subregion of the parameter space and virtually not in other regions.

A so-called random sequence algorithm generates a sequence of grid points quasi-randomly (“quasi-random”, a so-called “low-discrepancy sequence”, i.e. sequence with low discrepancy). A known and particularly preferred method for the generation of such a quasi-random sequence with low discrepancy is the “sobol sequence” method.

Sequences with low discrepancy are also called quasi-random sequences on account of their frequent use as a replacement for uniformly distributed random numbers. The modifier “quasi” is used to make it clearer that the values of a sequence with low discrepancy are neither random nor pseudo-random, but such sequences have some properties of random variables and, in specific applications such as the quasi-Monte Carlo method, the lower discrepancy of which is common, can be advantageous.

In one example, the space of the grid structure has three dimensions, wherein these span the wind conditions shear exponent, air density and extreme turbulence intensity. The wind speed increases with altitude and the wind moving in the vicinity of the earth's surface is braked by obstacles such as buildings, trees and the like. The deceleration of the wind along the surface is the so-called “wind shear”. Wind shear can be expressed as: v/vₒ=(h/hₒ)^{α}, where v=the wind speed at the altitude h (m/s), vₒ=the wind speed at the altitude hₒ (m/s) and α=the wind shear exponent or shear exponent. In order to be able to use the prediction model also for other hub heights, the input wind shear exponent is converted internally into a shear equivalent which has equivalent loads. It is a characteristic variable which is determined within the prediction process in order to extend the model validity (in this case to any hub heights without having considered a plurality of hub heights during training).

It has been found that the shear exponent together with the air density and an extreme turbulence intensity allows for prediction of the loads with high accuracy, wherein the number of parameters used remains as low as possible in order to reduce the complexity.

The wind conditions accordingly can include at least three parameters from the following or parameters derived therefrom:
wind speed
turbulence intensity
wind shear
inclined incident flow
air density.

The wind conditions can include all of the parameters mentioned or parameters derived therefrom.

According to a further example of the first aspect of the disclosure, the grid points comprise specific characteristic variables in addition to the wind conditions.

The further characteristic variables include in particular characteristic variables which describe the load quantities, such as, for example, type (force, torque, etc.), position on the wind turbine and direction of action, and characteristic variables which describe the wind turbine itself, such as, for example, rated power and speed, hub height, rotor diameter, etc.

Parameters which reduce the complexity for the models are preferably also set for the training. Thus, for example, the data and thus also the models for discrete values can be split. This can be done for the load type and load position and also for the wind speed, since these are usually only required discretely in the prediction.

According to a further example of the first aspect of the disclosure, the step of creating a grid structure with grid points creates the grid structure with grid points from randomly varied wind conditions as parameters and operating parameters, wherein the operating parameters are specific operating parameters for different operational modes of the wind turbine and comprise a rated power and/or a rated rotational speed and/or a rated wind speed and/or a starting wind speed and/or a cut-off wind speed.

The operating parameters are accordingly to be used according to the above-described turbine-specific characteristic variables and interchangeably therewith. In this aspect, the consideration of different operational modes is now added. The different operational modes are, for example, a normal operation, a noise-reduced operation, an operation with reduced power, etc. Special operational modes such as storm regulations or an operation to avoid wake effects can also be included. In all these different operational modes, different loads can occur on the wind turbine, so that these are to be considered for the prediction.

The operational modes, also denoted as OMs by the English “operational mode”, can be characterized, for example, via characteristic variables such as speed, thrust and power curves, product of power coefficient and average kinetic energy of the turbulence (TKE) as well as the critical aerodynamic damping, without being restricted thereto.

The ML models generated in this way are able to perform load predictions for any new combinations of input parameters. Thus, for example, it can be tested whether the development of a new OMs or a new component with specific parameters would be useful on the load side and thus economically. One example is the development of a new OMs for maximum power output, with full utilization of the mechanical load capacity. Another example is the development of a new tower which has optimized parameters for the desired sites.

According to another example, the step of load simulation of a wind turbine is performed for each of the grid points for the different operational modes of the wind turbine.

For a few operational modes, for example for less than seven operational modes, the simulation of all operational modes is particularly useful.

If a very large number of operational modes are to be taken into account, the considered number of grid points per operational mode can be reduced, or, in one example, the parameters of the operational modes are to be varied quasi-randomly together with the wind conditions. The number of grid points is thereby reduced without impairing the prediction accuracy of the model.

According to one example, in the step of determining the loads, the loads for any combination of wind conditions and any combination of operating parameters are determined using the prediction model.

The flexibility of the prediction model is thereby increased in that a greater diversification of the input parameters allows a wider use. The high dimensionality of the input parameter space can be handled by the use of prediction models, which is not the case with structured grids of the input parameter space.

According to another example of the first aspect of the disclosure, the method further comprises the following steps: creating a data set based on the grid structure and the results of the load simulation and in particular additional parameters, preferably an average kinetic energy of the turbulence or a thrust coefficient, training the prediction model on the basis of the data set.

The additional parameters can be added to the data set before or after the load simulation. Thus, some parameters influence an individual load simulation (e.g. wind speed) and others do not (shear-equivalent).

In the end, in the data which correspond to a grid structure and are used for training, there are values which are already known before the load simulation and values which are only known thereafter. When all values are combined to form a data set is not technically relevant as long as dependencies are adhered to. Accordingly, advantageous effect of the created data set results.

According to a second aspect of the disclosure, a training data set for training a prediction model for the prediction of loads based on wind conditions is proposed, comprising a grid structure with grid points from randomly varied wind conditions as parameters, in particular comprising a turbulence, a turbulence intensity and/or a wind shear, and results of load simulations of a wind turbine for each of the grid points.

In one example, the method comprises a load prediction for any new combination of site parameters, load quantities and operating parameters and thus in particular a feasibility test for not yet developed components and/or turbine control.

Furthermore, a training data set for training a prediction model for the prediction of loads based on wind conditions is proposed, comprising, for each grid point of a grid structure from randomly varied wind conditions as parameters, in particular comprising a turbulence, a turbulence intensity and/or a wind shear: the wind conditions of the grid point and results of load simulations of a wind turbine for the grid point.

### BRIEF DESCRIPTION OF THE DRAWINGS

The disclosure and preferred embodiments are described further below with reference to the attached figures. In the figures:

FIG. 1 illustrates schematically and by way of example a wind turbine;

FIG. 2 illustrates schematically and by way of example a wind farm;

FIG. 3 illustrates an overview diagram of the method according to the disclosure.

### DETAILED DESCRIPTION

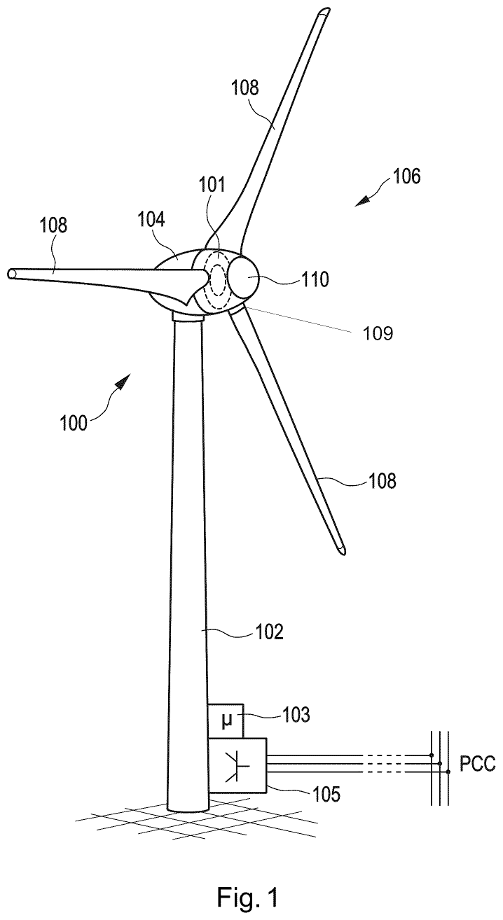

FIG. 1 illustrates a wind turbine 100 with a tower 102 and a nacelle 104. A rotor 106 with three rotor blades 108 and rotor blade roots 109 and a spinner 110 is arranged on the nacelle 104. During operation, the rotor 106 is set into a rotational movement by the wind and thereby drives a generator in the nacelle 104.

In this case, the wind turbine 100 has an electric generator 101, which is indicated in the nacelle 104. Electric power can be generated by means of the generator 101. The blade angles of the rotor blades 108 can be changed by pitch motors at rotor blade roots 109 of the respective rotor blades 108. A feed unit 105, which can be designed as an inverter, is provided for feeding in electric power. A three-phase feed current and/or a three-phase feed voltage according to amplitude, frequency and phase can thus be generated for feeding in at a grid connection point PCC. This can take place directly or else together with further wind turbines in a wind farm. A turbine controller 103 is provided for controlling the wind turbine 100 and also the feed unit 105. The turbine controller 103 can also obtain default values externally, for example from a central farm computer.

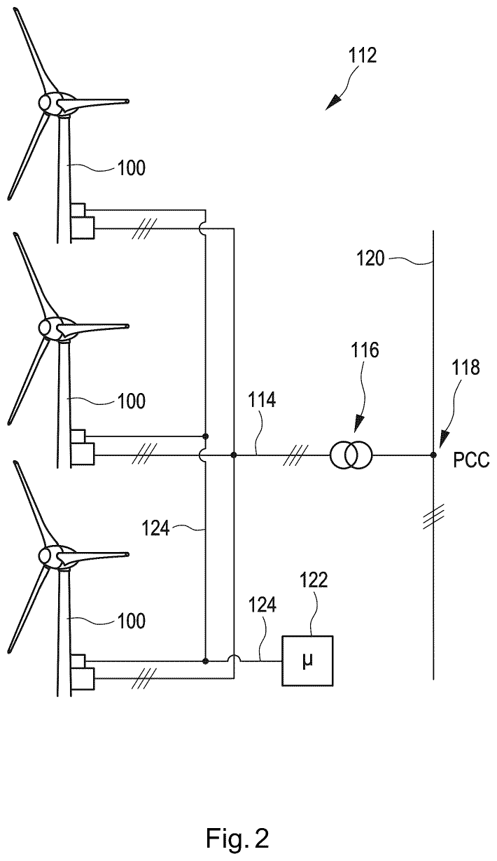

FIG. 2 illustrates a wind farm 112 with, by way of example, three wind turbines 100, which can be identical or different. The three wind turbines 100 are thus representative of basically any number of wind turbines of a wind farm 112. The wind turbines 100 provide their power, namely the generated current, via an electric farm network 114. In this case, the respectively generated currents or powers of the individual wind turbines 100 are added up and a transformer 116 is usually provided, which steps up the voltage in the farm in order then to feed it into the supply network 120 at the feed point 118, which is also generally denoted as PCC. FIG. 2 is only a simplified illustration of a wind farm 112. By way of example, the farm network 114 can be configured differently by virtue of, for example, also a transformer being present at the output of each wind turbine 100, in order to mention just another exemplary embodiment.

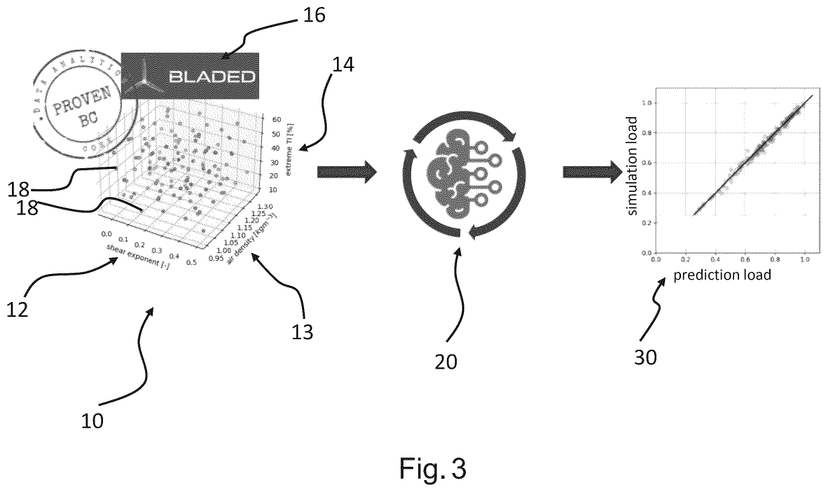

FIG. 3 illustrates schematically and by way of example an overview diagram of the disclosed method.

The disclosure consists in replacing time-consuming and resource-consuming calculations/simulations by ML models by virtue of the database required for model creation being created by a few calculations/simulations in unstructured, quasi-random grid structures 10.

In the example shown, the grid structure 10 is three-dimensional and comprises a shear-equivalent 12, an air density 13 and an extreme turbulence intensity 14. In this example, the shear-equivalent 12, the air density 13 and the extreme turbulence intensity 14 are the wind conditions as parameters of the grid structure.

The grid structure 10 is drawn schematically as a three-dimensional grid in which a plurality of grid points 18 are imaged at randomly arranged points. The grid points 18 are thus not generated in a structured grid but rather, for example, using a random sequence algorithm.

A load simulation 16 of a wind turbine 100 is performed for each of the grid points 18, for example using the program BLADED.

A training data set is generated from the grid points 18 and the loads calculated therefor, with which training data set an ML model 20 is trained. A validation result 30, which shows the correspondence between simulation on the vertical axis and prediction of the ML model 20 on the horizontal axis, demonstrates the effectiveness of the proposed method. A convincing prediction accuracy of the ML model 20 can be generated using a manageable quasi-random number of grid points 18 and simulations to be carried out therewith.

In order to increase the model quality, considered input parameters can be reduced or converted to specific characteristic variables. Examples thereof are rated power and rated wind speed for describing an operational mode (see application case 2 below by way of example) or a conversion of the wind shear to the shear-equivalent 12, which acts in the case of a different hub height load equivalent (see application case 1 below by way of example).

Application case 1 by way of example:

A cause of damage, for example on towers or rotor blades, was not sufficiently clarified. As a possible cause, a site-specific exceeding of the mechanical load capacity by extreme loads on account of extreme turbulence has been held to be possible. As a result of this, all sites of the affected WEA types with the load situation DLC 1.3 (extreme load in the case of extreme turbulence) should be examined with site conditions.

On account of the large number of sites, a check via the manual path by multi-body simulation (MKS) could not be implemented, just as a systematic combination of all parameter combinations and application of mathematical interpolation methods.

As a solution, a quasi-random sampling together with machine learning (ML) methods has proven itself in order to develop a model for site-specific load forecasts. On account of the short response time of ML models, all problematic sites can thus be tested.

In the application case 1 by way of example, therefore, quasi-random combinations of site parameters are determined and the associated mechanical loads are determined by multi-body simulation (MKS) for affected wind turbine types (WEA types). The load results can be combined with the site parameters to form a data set. ML models are generated with this data set, which subsequently supply load forecasts for the blade loads in the extreme load case DLC 1.3 on the basis of a new combination of site parameters.

In order to obtain a tower-independent forecast model, the model input wind shear is converted to a shear-equivalent 12 when the model is used. The shear-equivalent serves the model as a load-equivalent variable for the wind shear in a tower variant which is different from that considered when creating the model.

Application case 2 by way of example:

The individualization of the WEA types by different, customer- and site-specific optimized operational modes (OMs) should be possible. This individualization should serve, for example, to reduce the sound emissions or else to increase the yield without exceeding the mechanical load limits (fatigue and extreme loads). For this purpose, a plurality of different OMs and additional load cases must now be considered when determining the site-specific loads. Further site parameters are also to be taken into account. Furthermore, in the WEAs of a wind farm, different OMs should be operated, for example, depending on the installation position and the wind direction. Since the selection of an optimum combination of OMs must take place in a software-supported manner by an optimizer, the response time for the site-specific load evaluation should be kept as short as possible.

Here, too, it is an achievement of the present disclosure to be able to solve the posed problems by means of a sampling over a quasi-random grid structure, with development of specific characteristic variables and subsequent use of ML.

In the application case 2 by way of example, therefore, quasi-random combinations of site parameters are determined and the associated mechanical loads are determined by MKS for different operational modes (OMs) of a turbine variant. The load results are combined with the site parameters to form a data set and supplemented by OM-specific parameters. OM-specific parameters can be, for example, rated power, rated rotational speed, rated wind speed and starting and cut-off wind speed. If appropriate, the data set is enriched with further parameters which have a relationship between site parameters and load quantities. Examples of such parameters are the average kinetic energy of the turbulence (TKE) or the thrust coefficient (ct). ML models are subsequently trained with the data set, which subsequently supply load forecasts for fatigue and extreme load cases on the basis of a new combination of site and OM parameters.

It is also possible with this disclosure to perform a feasibility test for not yet developed components or turbine control (e.g. OMs). For this purpose, the OMs are characterized, for example, via characteristic variables such as speed, thrust and power curves, product of power coefficient and TKE, and/or the critical aerodynamic damping. The ML models generated in this way are able to perform load predictions for any new combinations of input parameters. Thus, for example, it can be tested whether the development of a new OMs or a new component with specific parameters would be useful on the load side and thus economically. One example is the development of a new OMs for maximum power output, with full utilization of the mechanical load capacity. Another example is the development of a new tower which has optimized parameters for the desired sites.

With the disclosure, extreme and fatigue loads for relevant load cross sections for specific wind speeds can be predicted and considered as a function of the wind distribution.

In comparison to the previous procedure with structured grids and mathematical interpolation, in this disclosure a substantially lower data volume and in the course of this also an increase in the dimensionality is ensured, which firstly enables some applications such as, for example, the individualization of operational modes. The ML models enable fast response times for otherwise time-consuming/resource-consuming calculations/simulations. Furthermore, new developments can be parameterized in a targeted manner.

1. A method for determining loads on wind turbines comprising:
creating a grid structure with grid points from randomly varied wind conditions as parameters, the wind conditions including one or more of a turbulence, a turbulence intensity, and a wind shear;
performing load simulation of a wind turbine for each of the grid points;
providing a prediction model for predicting loads based on wind conditions;
training the prediction model based on the load simulation for each of the grid points; and
determining the loads for any combination of wind conditions using the prediction model.

2. The method according to claim 1, wherein the load simulation comprises a multi-body simulation of entirety of the wind turbine.

3. The method according to claim 1, wherein different prediction models are created for different loads, for the different loads including blade loads and tower loads.

4. The method according to claim 1, wherein the grid structure has an approximately constant density of the grid points over a space, created using a random sequence algorithm.

5. The method according to claim 1, wherein the wind conditions comprise a shear-equivalent parameter determined based on a wind shear.

6. The method according to claim 1, wherein the wind conditions comprise at least three parameters from a plurality of parameters including
wind speed,
turbulence intensity,
wind shear,
inclined incident flow,
air density, or
one or more parameters derived from the plurality of parameters.

7. The method according to claim 6, wherein the wind conditions comprise all of the plurality of parameters mentioned or the one or more parameters derived therefrom.

8. The method according to claim 1, wherein the grid points comprise specific characteristic variables in addition to the wind conditions.

9. The method according to claim 1, wherein the grid structure is created with the grid points from randomly varied wind conditions as parameters and operating parameters, wherein the operating parameters are specific operating parameters for different operational modes of the wind turbine and one or more of:
a rated power,
a rated rotational speed,
a rated wind speed,
a starting wind speed, and
a cut-off wind speed.

10. The method according to claim 9, wherein the load simulation of the wind turbine is performed for each of the grid points for different operational modes of the wind turbine.

11. The method according to claim 10, wherein the loads are determined for any combination of wind conditions and any combination of operating parameters using the prediction model.

12. The method according to claim 1, wherein the grid structure further comprises operational modes and parameters of different operational modes are varied quasi-randomly for generating the grid points.

13. The method according to claim 1, further comprising:
creating a data set from the parameters of the grid points, the parameters including site parameters, results of the load simulation, load quantities, at least one operating parameter, and at least one additional parameter, which comprises a relationship between the site parameters and the load quantities, and
training the prediction model based on the data set.

14. The method according to claim 13, further comprising:
performing a load prediction for any new combination of the site parameters, the load quantities and the operating parameters and a feasibility test for to be developed components and turbine control.

15. The method according to claim 1, wherein the prediction model is trained using a training data set comprising, for each of the grid points;
one or more of a turbulence, a turbulence intensity and a wind shear,
the wind conditions of the grid point; and
results of load simulations of the wind turbine for the grid point.

16. The method according to claim 13, wherein the relationship includes one or more of an average kinetic energy of the turbulence and a thrust coefficient.
